(19) United States
(12) Patent Application Publication
(10) Pub. No.: US 2003/0035381 A1
(43) Pub. Date: Feb. 20, 2003

(54) Network-based teleconferencing capabilities utilizing data network call set-up requests

(76) Inventors: Yihsiu Chen, Middletown, NJ (US); Mark Jeffrey Foladare, East Brunswick, NJ (US); Shelley B. Goldman, East Brunswick, NJ (US); Kevin Stone, Fair Haven, NJ (US); Shaoqing Q. Wang, Morganville, NJ (US); Roy Philip Weber, Bridgewater, NJ (US); Robert S. Westrich, Middletown, NJ (US); Aleksandr Zelezniak, Matawan, NJ (US)

Correspondence Address: Samuel H. Dworetsky, AT&T CORP, P.O. Box 4110, Middletown, NJ, 07748-4110, US

(21) Appl. No.: 09/931,428

(22) Filed: Aug. 16, 2001

(51) Int. Cl. H04B 1/44

(52) U.S. Cl. 370/261; 370/282

(57) ABSTRACT

A data network-based teleconferencing platform is implemented to allow individuals to set up and control conference calls over the conventional voice network, even individuals without direct access to a teleconference-enabling element (such as a PBX switch). A network-controlling server (such as a CTI server), in conjunction with a web server, are located in the data network and used to interface between the individual and a conventional conference element (such as a PBX switch). The web server responds to data commands from the indvidual to set up a conference call, and may use directory listings stored in a data base at the platform to retrieve the necessary call set-up information. The call set-up information is then sent from the web server to the CTI server, which translates this information into telecommunication commands and forwards the commands to the PBX switch, where the PBX switch then sets up the call in its usual fashion. A scheduling element may be used to facilitate the organization of a conference call, storing information for regularly-scheduled calls, and the like, and a notification element may be used to alert participants about an up-coming conference call.

### TECHNICAL FILED

The present invention relates to teleconferencing and, more particularly, to extending the ability to set-up and control a teleconference, using a data network, to an individual, regardless of the individual's ability to directly access conferencing capabilities.

### BACKGROUND OF THE INVENTION

A conference call is a telephone call in which three or more parties, each at a respective location, are capable of simultaneous participation. One technique used to initiate a conference call involves the originating party separately dialing each terminating party participating in the conference call, and “bridging” the calls together as they are connected in turn. In this method, the initiator's telephone must be directly connected to a PBX switch or other equipment capable of bridging together telephone calls. Most residential telephones, cell phones, etc. lack this type of capability, which is primarily seen in office environments.

Another technique for establishing a conference call involves providing a “dial-in” telephone number used to join the participants at a common bridge in a telecommunications network. Since each participant is separately capable of dialing into the bridge, the above restriction on telephone-based bridging capabilities has been overcome. However, this network-based technique requires that the conference call be pre-arranged well in advance so that use of the service may be reserved and each of the participants informed of the call-in number and when to dial into the network. Moreover, since such an arrangement is usually offered by a telecommunications service provider, a cost is associated with both the call set-up and the actual conference call itself.

A more recent form of conferencing utilizes digital networks, such as the internet, that are publicly accessible by individual computers (typically PCs) via Internet Relay Chat (IRC) hosts. The conferees come on line and are interconnected by means of the host, and may utilize software which allows fully-duplexed communication between the PCs. Typically, the conference is conducted with the exchanged information visually appearing on the individual display screens. In more sophisticated applications allowing audio communication between the conferees, additional hardware is required at each PC site. A microphone and A/D converter provide digitized audio input to a PC by means of appropriate software and the audio output is derived from the digital information transmitted over the internet by use of a D/A converter feeding a speaker. Hence, a conference of multiple conferees requires additional hardware and software at each PC site in order to implement a conference by means of the internet. Additionally, such an arrangement excludes participation by those individuals that do not have access to an internet connection at the time of the conference call.

### SUMMARY OF THE INVENTION

The present invention relates to teleconferencing and, more particularly, to extending the ability to set-up and control a teleconference, using a data network, to an individual, regardless of the individual's ability to directly access conferencing capabilities.

In accordance with the present invention, data network capabilities are utilized to allow an individual to set up and participate in a telephone conference call in situations where the individual may not be co-located with a switch (such as a PBX) that can arrange such a call. The PBX switch (or other suitable conferencing element) may be disposed as customer premise equipment (CPE) at a particular business or other location, or may be a network-based switch, shared by a number of different subscribers. The use of the data network to set up the conference call removes the need to either be co-located with the PBX switch, or to contact a network service provider specialist to set up the call. In particular, an individual with data network access to a remote office platform utilizes that connection to communicate with both a network-controlling server (e.g., a computer/telephony interface (CTI) server) and a web server at the platform. The network-controlling server is utilized to control the operation of a PBX switch to set up a conference call as directed by the individual. A database at the platform is used to store various directory listings used for conference call purposes. The web server interacts with the database and the network-controlling server to effectuate the call.

In one embodiment of the present invention, a scheduler and notification server are also located at the platform and utilized in conjunction with the web server to set up a conference call. The scheduler communicates with the network-controlling server regarding the time of a call and the identity of the participants. The notification server is used to send messages to the participants, alerting them to the upcoming call. Various means can be used to send the notification. The scheduled participants, in one embodiment, can also reply to the notification, sending messages regarding their availability, change of “reach” number, etc.

A conference call can also be set up in “real time”, in accordance with the present invention, using the web server and database to directly send messages to the network-controlling server, which in turn contacts the proper PBX switch to launch the outbound calls to the conference call participants.

In either embodiment, a conference participant can also call into the platform and add himself to a pre-existing conference call, where this inbound call will stop the platform's attempt to reach the participant through an outbound call.

In any alternative, a “voice server” (comprising a VRU with additional bridging capabilities) may be used in place of the web server, affording an alternative interface that allows the same set up and execution to be performed over the telephone, and can also be used in conjunction with the scheduler and database. In any embodiment, the PBX may be located in the network, as can the voice server.

Other and further aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary network architecture for implementing the conference call arrangement of the present invention.

### DETAILED DESCRIPTION

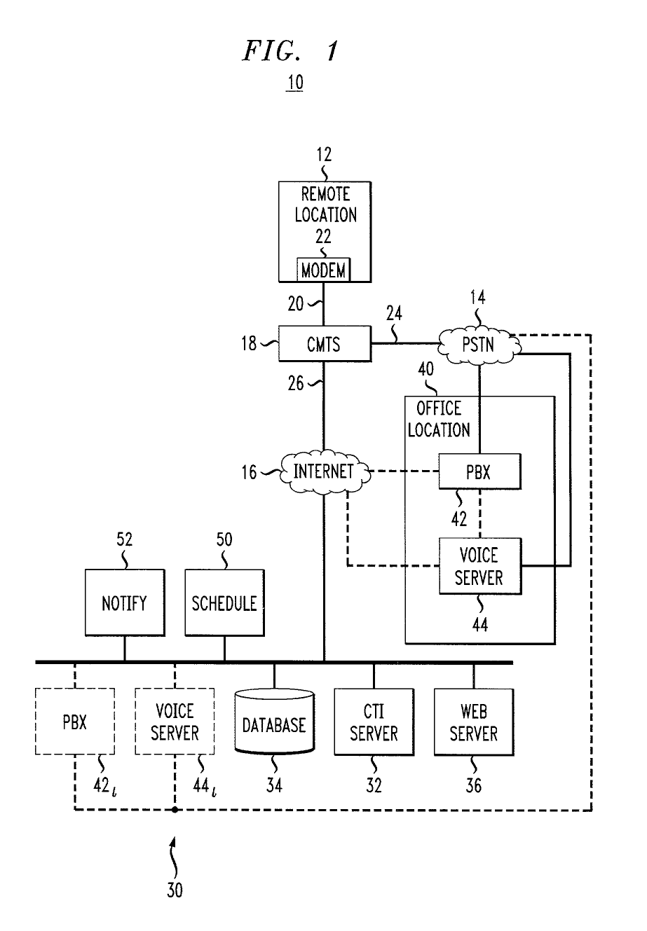

A simplified diagram of an exemplary network architecture 10 for implementing the teleconferencing arrangement of the present invention is illustrated in FIG. 1. In general, the teleconferencing capability as described below allows an individual at any location 12, even a remote location, (“remote” meaning, for example, an individual working at a location “remote” from his/her office and lacking direct interconnection with a PBX switch and its advanced feature functionality) to organize and participate in a telecommunications conference call. It is to be understood that in the general case, the invention is not limited to the situation where an individual is “remote” with respect to conference capabilities. Indeed, the use of a data network and teleconferencing platform in accordance with the present invention enables various call set-up and control/scheduling options that may be not be available through either a traditional PBX switch or teleconferencing service. Thus, the benefits afforded by using the platform of the present invention can be available to all individuals, whether or not they have conferencing capabilities at their current location. For the purposes of describing the operation of the invention, a particular situation will be discussed including a “remote” individual. However, this limitation should not be construed to limit the scope of the disclosed invention.

Referring back to FIG. 1, remote location 12 is connected to both a telecommunications network 14 (such as the PSTN) and a data network 16 (such as the Internet) through a network control element 18. There exist in the art various arrangements for providing this interconnection, for example, a hybrid fiber coaxial (HFC) interconnection, with a cable connection 20 between network control element 18 and a cable modem 22 located at remote location 12, and a pair of fiber connections 24, 26 between network element 18 and PSTN 14 and Internet 16, respectively. Other arrangements are possible and any suitable communication structure may be used in providing the teleconferencing arrangement of the present invention.

In accordance with the teachings of the present invention, a remote platform 30, interconnected to both PSTN 14 and Internet 16, is used to provide teleconferencing set-up capability. Platform 30 includes a network-controlling (e.g., CTI) server 32 that responds to data network commands received from remote location 12 via Internet 16 and translates the commands into telecommunications commands used to control a PBX switch, such as PBX switch 42 disposed at an office location 40 (office location 40 being defined as the office associated with the individual currently at remote location 12). As an alternative, a PBX switch (such as switch 42i illustrated in phantom in FIG. 1) may be located in the network and used to provide conference call connectivity. Referring back to FIG. 1, a database 34 is located at platform 30 and includes various directory listings associated with the individual setting up the conference call, where these listings can be used to facilitate the set up of a conference call. For example, database 34 may include a “group” listing of all co-workers involved in a project, allowing the individual at the remote location to merely request a conference call be set up with “Group X”. CTI server 32 will then access database 34, retrieve the Group X listing of telephone numbers, and pass this set of numbers to PBX 42 to establish the conference call.

Throughout the remainder of this discussion, any reference to PBX 42 may also be presumed to include reference to network-based PBX 42ᵢ, since a network-based element is capable of performing all of the same functions as a customer premise-based element. Moreover, a voice server 44 that will be discussed in detail below, may also be located any where in the network and provide the same functionality. Indeed, in its most general form, the physical location of either of these components is not relevant to the purpose of providing conferencing service in accordance with the present invention.

The use of a data network interface/web server in accordance with the present invention as a call-setup mechanism provides a robust, user-friendly interface at any PC to easily arrange teleconference call details. The flexibility imparted by using a data network and teleconference platform allows for various types of calls to be initiated by an individual. For example, using a pre-provisioned directory listing stored in data base 34, the user may have the listings appear on a computer screen and “click” to select the individuals (or group(s)) to be included on the teleconference. Alternatively, the user may enter one or more numbers via his PC and send this information, along with the “conference ” command, back to CTI server 32. In any case, the calls will be dialed out by PBX 42 one by one, regardless of the number of call participants. Such a conference can be implemented in “real time”, that is, the user at the remote location may “click” on a “conference” feature on a PC screen, pull up the listing and send the command to CTI server 32 to set up a conference call on these lines “now”. CTI server 32 will, in turn, pass this command to PBX 42 via PSTN 14, and PBX 42 will performing the actual dialing out and bridging together of the conference participants.

A web server 36 is also located at platform 30 and is used to create and control the interface presented to the individual during the set up and execution of a conference call. In particular, web server 36 is used in conjunction with a schedule element 50 (also located at platform 30), notification server 52 (at platform 30) and database 34 to effectuate the conference call set up. Scheduling element 50 receives various inputs from web server 36, such as the conference call date, conference call time, participant name/reach number list, etc. As a further feature of the preset invention, scheduling element 50 may be used to store a listing of “recurring” conference calls (e.g., setting up a sales review teleconference call every Wednesday morning at 9 AM, EST). Scheduling element 50 also sends information to CTI server 32, which will use CTI messages to direct PBX 42/42ᵢ to reserve the necessary switching resources (i.e., ports) for the call, and launch the outbound calls at the appropriate time to reach the call participants.

Scheduling element 50 directs notification server 52 to send out conference information to all participants through means such as email, instant messaging, or any other data network type of “alert”. Alternatively, notification server 52 may use PSTN 14 to send a page, voicemail, fax message, or the like, to notify the participants of an upcoming conference call. Indeed, virtually any method of establishing communication with each conference call participant may be used.

Alternatively, a conference call can be set up in “real time” using the arrangement of the present invention, using web server 36, in conjunction with database 34, to direct CTI 32 to immediately start the call set up procedure. As in the arrangement discussed above, CTI server 32 will use CTI messages to direct PBX 42/42ᵢ to immediately begin the call set up, launching outbound calls to reach participating parties. It is to be noted that the same function as web server 36 can be performed by voice server 44, which will then interact with CTI 32 to request the call set up.

In either the “scheduled” or real-time embodiment of the present invention, a conference participant can call into platform 30 and add him/herself to a pre-existing conference call. Voice server 44 (either co-located with PBX 42 or at platform 30 (as voice server 44ᵢ)) may be used with this particular “meet me” aspect of conference call, where an individual calling in to a conference call is bridged onto the call. This is particularly useful if an indvidual who wants to join the call is not at his “reach” number at the time of conference call. CTI server 32 functions to monitor for the presence of such an inbound call and, when recognized, will send a command to PBX 42/42ᵢ to drop the outbound call attempt to that particular individual. If voice server 44 is co-located with PBX 42, a connection between PBX 42 and voice server 44 will be established for the duration of the conference call (and dropped once the call is completed to free-up a port on PBX 42). Alternatively, if voice server 44ᵢ is located at platform 30, CTI server 32 will send a message to PBX 42 to establish an outbound call to voice server 44ᵢ and establish the conference call at that point. It is to be understood that while the connection between voice server 44/44ᵢ and PBX 42/42ᵢ is used to carry voice traffic, the signal path may comprise a traditional circuit-switched path or a data communication path, such as an RTP stream used for VOIP (voice-over IP) or through a LAN.

While the present invention has been described in connection with the illustrated embodiment, it will be appreciated and understood that modifications may be made without departing from the true spirit and scope of the invention. For example, as discussed above, network-based PBX switches and voice servers may be utilized as easily as those at customer premise locations. Moreover, the individual servers and elements resident at the teleconference platform may be configured in various combinations or sub-combinations and still provide the same functionality as the individual components discussed above (i.e., web server, notification element, database, scheduling element). It is to be understood that the particular embodiment shown above and described is by way of illustration and in no way intended to be considered limiting. Therefore, references to details of a particular embodiment are not intended to limit the scope of the claims, which in themselves recite only those features regarded as essential to the invention.

What is claimed is:

1. A method of providing conference call capabilities using a data network for call set-up, the method comprising the steps of:
a) providing voice and data communication paths from voice and data communication networks to an individual's communications device;
b) providing a teleconference platform coupled between said communications device and a teleconference-enabled switch; and
c) in response to a teleconference set-up command received at said teleconference platform from said communications device via the data communications network, forwarding the set-up command to the teleconference-enabled switch.

2. The method as defined in claim 1, wherein the method further comprises the step of:
d) in response to receiving the set-up command at the teleconference-enabled switch, extending outbound calls over the voice communication network to conference call participants; and
e) bridging the outbound calls together to form a conference call.

3. The method as defined in claim 1 wherein in performing step b), providing a database of directory listings at the teleconferencing platform, said database including individual and group listings of names and telephone numbers to facilitate the selection of participants for a teleconference call.

4. The method as defined in claim 1 wherein in performing step b), providing a network-controlling server at the teleconference platform for responding to teleconference commands from the data communication network, translating said data network commands into telephony-based teleconferencing commands and transmitting said telephony-based teleconference commands via the voice communication network to the teleconference-enabled switch.

5. The method as defined in claim 4 wherein in performing step b), further providing a web server at the teleconference platform to communicate between the individual's communications device and the network-controlling server.

6. The method as defined in claim 1 wherein in performing step b), providing a scheduling element at the teleconference platform for retrieving requested conference call time and listing of participants associated with the teleconference command and scheduling the teleconference call, in response to a teleconference command request received from a remotely-located user.

7. The method as defined in claim 6 wherein in performing step b), further providing a notification element at the teleconference platform for notifying each participant of the time and date for the conference call.

8. The method as defined in claim 7 wherein the notification is sent over the data communication network to at least one participant.

9. The method as defined in claim 8 wherein an email notification is sent.

10. The method as defined in claim 8 wherein an instant messaging notification is sent.

11. The method as defined in claim 7 wherein the notification is sent over the voice network to at least one participant.

12. The method as defined in claim 11 wherein a paging notification is sent.

13. The method as defined in claim 11 wherein a voicemail notification is sent.

14. The method as defined in claim 11 wherein a fax notification is sent.

15. A network-based platform for providing teleconference capabilities to remotely-located subscribers via a data network connection, the platform comprising
a network-controlling server for receiving data network-based commands related to teleconference set-up, translating the commands into telecommunications commands and forwarding the telecommunications commands to a teleconference-enabled switch; and
a web server responsive to teleconference commands received via a data communication network from subscribers and forwarding the commands to the network-controlling server.

16. The network-based platform as defined in claim 15 wherein the platform further comprises
a database of directory listings, accessible by subscribers via a data communication network and directly accessible by the web server, to provide telephone listing information to assist in the selection of conference call participants.

17. The network-based platform as defined in claim 15 wherein the platform further comprises
a scheduling element for storing requests for conference call dates and times, including a participant listing for each stored request; and
a notification element for sending a conference call alert to each participant included in the participant listing.

18. The network-based platform as defined in claim 17 wherein the scheduling element further includes a response module receptive to return information from participants and modifying information in the participant listing accordingly.

19. The network-based platform as defined in claim 15 wherein the network-controlling server comprises a computer/telephony interface (CTI) server.
